(19) United States
(12) Patent Application Publication
(10) Pub. No.: US 2007/0115270 A1
(43) Pub. Date: May 24, 2007

(54) Image manipulation apparatus

(76) Inventor: Barinder Singh Rai, Surrey (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/286,653

(22) Filed: Nov. 23, 2005

(51) Int. Cl. G09G 5/00

(52) U.S. Cl. 345/204

(57) ABSTRACT

Methods for manipulating the appearance of a source image are provided. One method includes specifying at least one first parameter for changing pixel data defining a source image, fetching the pixel data from a memory, writing pixel data to a display device, and causing a first change to the pixel data corresponding to the at least one first parameter before the step of writing pixel data to the display device. A step of discontinuing the step of causing a first change is also provided. This step reverses the first change. Also included are a graphics controller and a system for manipulating the appearance of a source image.

### FIELD OF THE INVENTION

The invention relates to digital image processing, and specifically to methods, apparatus, and systems for manipulating the appearance of digital images.

### BACKGROUND

While the images produced by a digital camera can be good, quite often they can be improved by adjusting various parameters, such as contrast, tonal balance, and the like. In addition, by adjusting such parameters it is possible to apply special effects to an image. Typically, adjustments of this type are made by transferring the digital image from the camera to a personal computer (“PC”) and modifying various image parameters using image manipulation software. The image manipulation software causes the source image to be rendered on a display device and provides a variety of user-selectable functions for manipulating the appearance of the image. The user selects one of the functions, and the software changes one or more parameters by changing the values of the individual picture elements (“pixels”) that make up the image, stores the modified pixels in a memory, and then causes the modified image to be fetched from the memory and written to the display.

Typically, a user will make several different types of adjustments to improve the appearance of an image, making successive modifications until satisfied with the appearance. As each adjustment is made, the software modifies the pixels, stores the modified image, and causes it to be written to the display so that the user can see the modification. Frequently, the user will specify an adjustment that is either more or less than is needed. In addition, when one parameter is adjusted, it often affects another parameter. For instance, adjusting the color balance can also change the contrast. Further, the user may experiment with a special effect, and after viewing the effect decide that it is not desired. For these situations, the software includes a function that permits the user to undo a manipulation made to the image.

In order to provide the undo function, the image manipulation software requires a region of primary or main memory that is large enough to store a minimum of two copies of the image. Initially, the original image in stored in the first region of the main memory. When the user selects an image manipulation function, a first modified image is in stored in the second region. As successive modifications are made, the original image is overwritten with a second modified image, and the first modified image is overwritten with a third modified image, and so on. This model permits a user to undo the most recent adjustment and revert to the previous image. The software may permit a user to reverse more than one manipulation, but in this case additional copies of the image need to be stored in the memory.

Modifying the appearance of an image using image manipulation software typically requires a PC equipped with a substantial amount of primary memory. Often the PC is located in a home or office. It would be desirable, however, to be able to manipulate at least some of the image parameters in any desired location using a mobile device, such as a camera-equipped mobile telephone, a personal digital assistant, a digital camera, a digital music player, or other similar devices. Being able to manipulate the appearance of an image in a mobile device would allow a user to see how a particular manipulation works in the field. If he is not satisfied, he may choose to modify the camera settings and re-take the picture rather than trying to perform a series of modifications. Further, the user may wish to see how a special effect looks before storing the image in the limited memory of a mobile device.

Mobile devices commonly include a graphics display system that includes a host, a camera, a display device, and a graphics controller. The graphics controller drives the display device, and interfaces the host and the camera with one another and with the display device. The graphics controller commonly includes a CODEC (compressor/de-compressor) for compressing digital images before storing them. In addition, the graphics controller commonly includes an embedded memory for storing image data. Because mobile devices typically rely primarily on a battery for power, it is important to minimize power consumption in these devices in order to maximize battery life. Further, it is important to minimize the size of the memory, which reduces cost and also reduces power requirements.

Accordingly, methods, apparatus, and systems for manipulating the appearance of digital images in mobile devices would be desirable. In particular, providing an undo function in a mobile device capable of manipulating the appearance of digital images without requiring a memory that is twice the size of the image would be desirable.

### SUMMARY

Generally, the present invention addresses the above described problems and need for providing an efficient undo function for use with manipulating the appearance of images. The present invention may be implemented in numerous ways, including as a method, an apparatus, or a system.

One aspect is directed to methods for manipulating the appearance of a source image that include steps of (a) specifying at least one first parameter for changing pixel data defining a source image, (b) fetching the source pixel data from a memory, (c) writing pixel data to a display device, and (d) causing a first change to the pixel data. The first change corresponds to the first parameter and the first change is caused before the step of writing the pixel data to the display device. In addition, a step of discontinuing the step of causing a first change may be provided. This step reverses the first change. Further, steps of specifying at least one second parameter for changing the pixel data, and causing a second change to the pixel data may be provided. The causing of a second change corresponds to the second parameter and is performed before the step of writing the pixel data the display device. Moreover, a step of discontinuing the step of causing a second change may be provided. This step reverses the second change.

Another aspect of the invention is directed to a graphics controller. Preferably, the graphics controller comprises image manipulation logic adapted for manipulating the appearance of an image and for undoing the manipulation. In one embodiment, this logic includes: (a) a fetching module for fetching source image pixel data from a source image memory; (b) a parameter memory for storing at least one first parameter for defining a manipulation of the source image pixel data; (c) a pixel modifying unit for causing a first manipulation of the source image pixel data corresponding to the first parameter; and (d) a writing module adapted for receiving pixel data output from the pixel modifying unit and for writing the received pixel data to a display device.

An additional aspect of the invention is directed to a system. The system preferably includes a graphics controller adapted for manipulating the appearance of an image and for undoing the manipulation. The graphics controller includes image manipulation logic, which preferably comprises: (a) a fetching module for fetching source image pixel data from a source image memory; (b) a parameter memory for storing at least one first parameter for defining a manipulation of the source image pixel data; (c) a pixel modifying unit for causing a first manipulation of the source image pixel data corresponding to the first parameter; and (d) a writing module adapted for receiving pixel data output from the pixel modifying unit and for writing the received pixel data to a display device.

Other aspects and advantages of the present invention will become apparent from the following detailed description and drawings.

### BRIEF DESCRIPTION OF THE DRAWINGS

FIG. 1 illustrates a graphics display system having a pixel modifying unit according to a preferred embodiment of the invention.

FIG. 2 illustrates the pixel modifying unit of FIG. 1 having a pixel distribution module.

FIG. 3 illustrates a preferred method for manipulating the appearance of a digital image in which an undo function is provided.

FIG. 4 illustrates an exemplary operation that may be performed by the pixel distribution module of FIG. 2.

### DETAILED DESCRIPTION

The inventions are directed to apparatus, methods, and systems for providing an undo function when manipulating the appearance of a digital image with a memory that is the size of the image. Reference will now be made in detail to specific preferred embodiments of the invention, examples of which are illustrated in the accompanying drawings. Wherever possible, the same reference numbers are used in the drawings and the description to refer to the same or like parts.

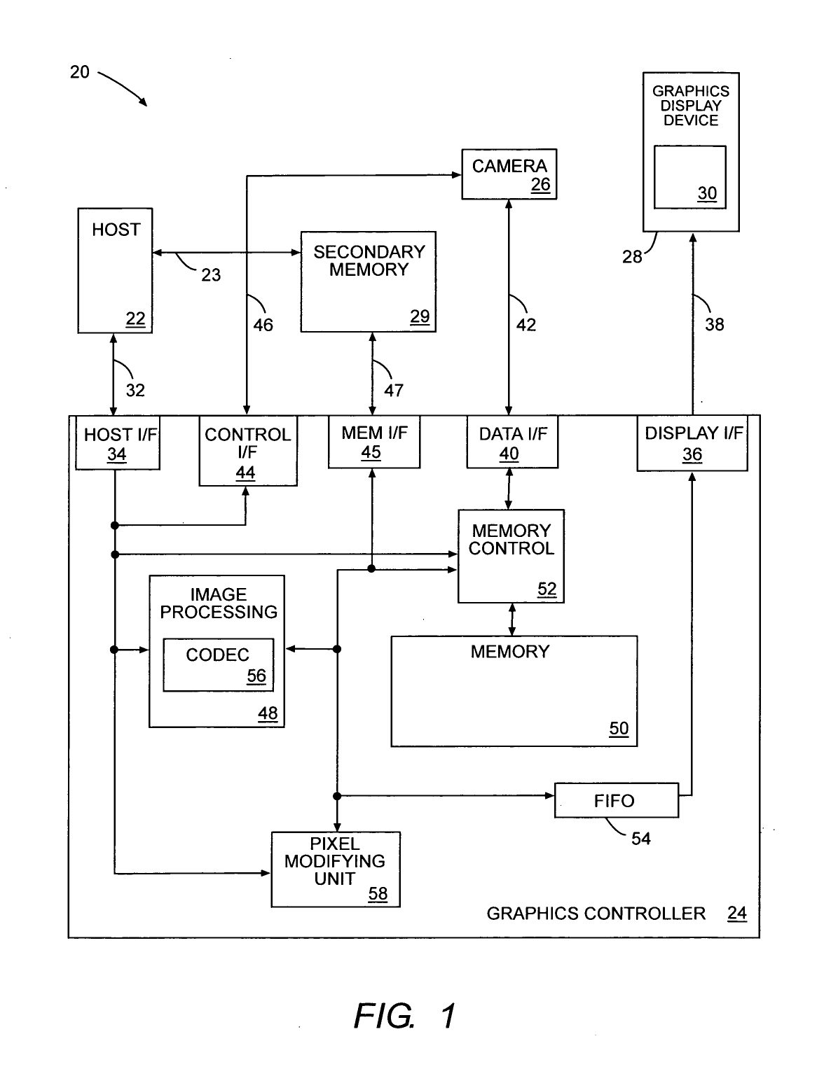

Methods and apparatus according to the present invention are particularly adapted for use in mobile devices and appliances. Examples of mobile devices and appliances include a camera-equipped mobile telephone, a personal digital assistant, a digital camera, a digital music player, and other similar devices. FIG. 1 depicts a graphics display system 20 that may be or be included in any digital system or mobile appliance. Where the system 20 is included in (or is) a portable appliance, it is typically powered by a battery (not shown).

The system 20 includes a host 22, a graphics controller 24, a camera module 26, a graphics display device 28, and a secondary memory 29. The system 20 may include additional components, as will be appreciated by one of ordinary skill in the art, but which are not important to the present invention and, accordingly, are omitted for purposes of clarity. The host 22 is typically a microprocessor, but may be a digital signal processor (“DSP”), or any other type of controlling device adapted for controlling digital circuits.

The graphics controller 24 drives the display device and interfaces the host and the camera module with the display device. Preferably, the graphics controller 24 is a separate IC (integrated circuit) from the remaining elements of the system, that is, the graphics controller is “remote” from the host, camera, and display device. The display device includes at least one display screen 30. LCDs are typically used as display devices in portable digital appliances, such as mobile telephones, but any device(s) capable of rendering pixel data in visually perceivable form may be employed.

The host 22 communicates with the graphics controller 24 over a bus 32 that is coupled to a host interface 34 in the graphics controller. The graphics controller 24 includes a display device interface 36 for interfacing the graphics controller with the display device 28 over a display device bus 38.

The graphics controller 24 includes a data interface 40 (“DATA I/F”) for receiving pixel data output on a bus 42 from the camera 26. Preferably, the bus 42 is a parallel bus. The camera 26 is programmatically controlled through a control interface 44. A bus 46 couples the control interface 44 to the camera 26. The bus 46 is preferably an inter-IC or I²C bus.

The secondary memory 29 is be coupled to the host 22 via a bus 23. In addition, the secondary memory 29 may be coupled to an external memory interface 45 in the graphics controller 24 via a bus 47. The secondary memory may be either a volatile memory, a non-volatile memory, or a combination of the two. For example, the secondary memory may be a disk drive, a flash memory module, an SRAM, a DRAM, some other type of computer memory, or some combination of these types.

A number of image processing operations may be performed on data provided by an image data source, such as the host or the camera. Such image processing operations may be performed by units included in an image processing block 48. The image processing block 48 may include, for example, a CODEC 56 for compressing and decompressing image data, and a resizer for scaling an image. The details of the image processing block will be known to one of ordinary skill in the art, but are not important to the present invention and, accordingly, are omitted for purposes of clarity.

In a preferred embodiment, the graphics controller 24 includes an embedded memory 50 for storing image and other data. In other embodiments, however, the memory 50 may be remote from the graphics controller. Data are stored in and fetched from the memory 50 under control of a memory controller 52. The memory 52 is preferably an SRAM, however, any type of memory may be employed.

In operation, the camera module 26 may capture an image which is provided to the graphics controller 24 as a frame of image data. Alternatively, the host may provide a frame of image data to the graphics controller 24. The graphics controller 24 performs various image processing operations on the image data to prepare the image for display. For instance, the image may be scaled, cropped, or converted from one color space to another.

When frames of image data are ready for display, they are stored in a frame buffer region of the embedded memory 50. Subsequently, the frames are fetched and transmitted through at least one display pipe 54 to the display device 28 via the display device interface 36 and the bus 38. Preferably, the display pipe 54 is a FIFO buffer. In order to display an image on a display device, it must be redrawn or refreshed many times per second. Typically, the refresh rate is around 60 times per second. Thus, frames of pixels are repeatedly fetched and transmitted to the display many times every second. The frames may be different, such as for displaying video, or the same frame may be repeatedly fetched and transmitted, such as when displaying a still image.

In a preferred embodiment, the graphics controller 24 includes a pixel modifying unit 58. The pixel modifying unit 58 is adapted for manipulating the appearance of an image and providing an undo function according to a preferred embodiment of the invention. In particular, the pixel modifying unit is adapted for changing the appearance of an image on a pixel-by-pixel basis. As the pixels of a frame are fetched from memory, the data values of the pixels are intercepted, examined, and selectively modified by the pixel modifying unit 58 before being presented to the display pipe 54 for transmission to the display. The pixel modifying unit 58 is coupled to the host 34, the memory 50 via the memory controller 52, and the image processing block 48. In addition, the pixel modifying unit 58 is coupled to the display pipe 54.

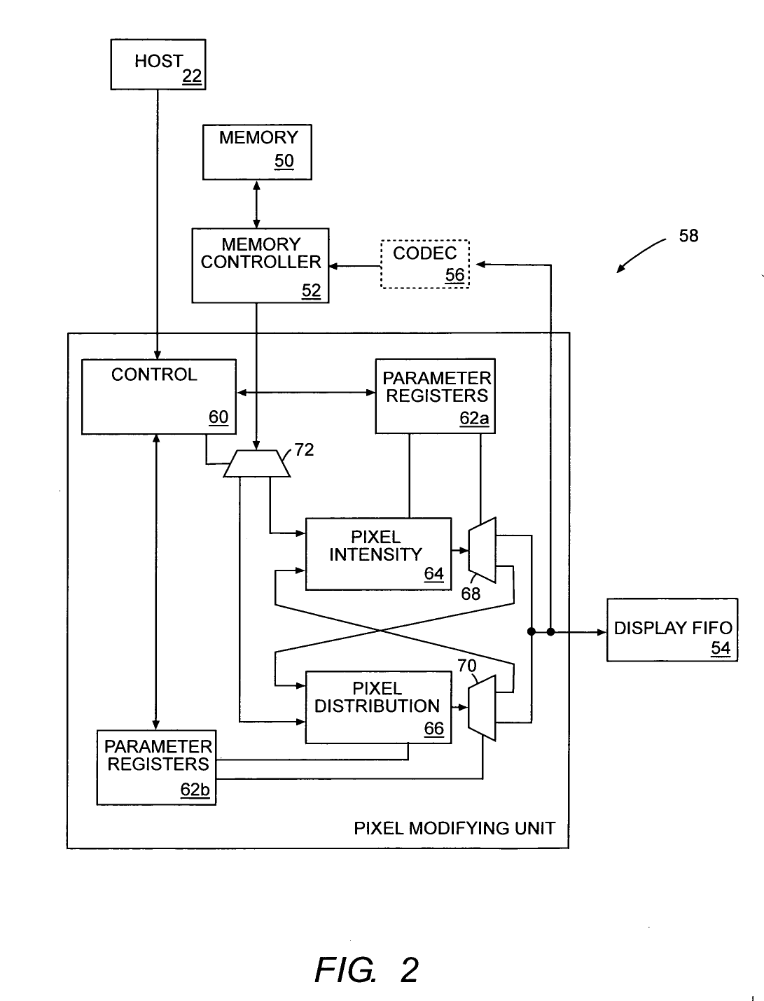

Referring to FIG. 2, the pixel modifying unit 58 includes a control module 60 for receiving commands and parameters from the host, and for controlling the operation of the modules within the pixel modifying unit 58. The parameters transmitted by the host are stored in registers 62a and 62b. In addition, the pixel modifying unit includes a pixel intensity module 64 for adjusting the numerical level of a pixel, and a pixel distribution module 66 also for adjusting the numerical level of a pixel. Under the direction of the control module 60, the pixel intensity and distribution modules 64, 66 may be employed individually or in combination. The pixel modifying unit 58 also includes selecting devices 68, 70, and 72 for directing inputs and outputs as shown in he FIG. 2. Additional logic may be included in the pixel modifying unit 58 for facilitating the operations described generally below, as will be appreciated by one of ordinary skill in the art.

The exemplary pixel modifying unit 58 shown in FIG. 2 is adapted for manipulating gray-scale images. However, the unit 58 may be modified for manipulating color images. To simplify the explanation of the inventions, the unit 58 for manipulating gray-scale images is described first. After the operation of the unit 58 has been described, the manner in which it may be modified for manipulating color images will be described.

Digital images consist of arrays of pixels that are typically gray-scale or color images. The brightness and color attributes of each pixel are represented by a numeric value. Typically, in a gray-scale image, the pixels are described by an 8-bit binary value (“level”) and can be any of 258 shades of gray, from 0 (black) to 255 (white). Color pixels are generally defmed by three values, being specified in one of a number of color models (a mathematical model for describing a gamut of colors). Color display devices generally require that pixels be defined by three 8-bit components in the red-green-blue (“RGB”) color model. Each color component can take a value (level) from 0 (minimum intensity) to 255 (maximum intensity), and when added they produce a pixel in any one of over 16 million colors. Color components are also referred to as color channels.

The pixel intensity module 64 is used for manipulating image attributes that may be adjusted by adding to or subtracting from a pixel's level. For example, an image's brightness attribute may be manipulated using the pixel intensity module 64. If a user wishes to increase the brightness of an image by 5 percent, the module 64 can be directed to add an increment of 13 to the level (value) of each pixel after it is fetched from memory and before it is written to the display pipe. Each fetched gray-scale pixel will have a level of 0 to 255. If a pixel with a level of 100 is fetched, it will be incremented and written to the display pipe as 113. It is contemplated that the user may specify that a uniform adjustment be made to all of the pixel in an image. However, it is also contemplated that the user may specify one of more sub-ranges within the full range of possible levels (0 to 255), with a different increment being added to each pixels within each sub-range. For instance, the user may specify that 13 be added to the pixels having levels 0 to 127, and that that 25 be subtracted from the pixels having levels 128 to 255. The parameters for specifying these increments and ranges may be stored in the registers 62a.

The pixel distribution module 66 is used for manipulating image attributes that require more than adding to or subtracting from a pixel's level. The pixel distribution module 66, in a preferred embodiment, may be used to make an adjustment requiring multiplying pixels level, and then adding or subtracting an increment to or from the product.

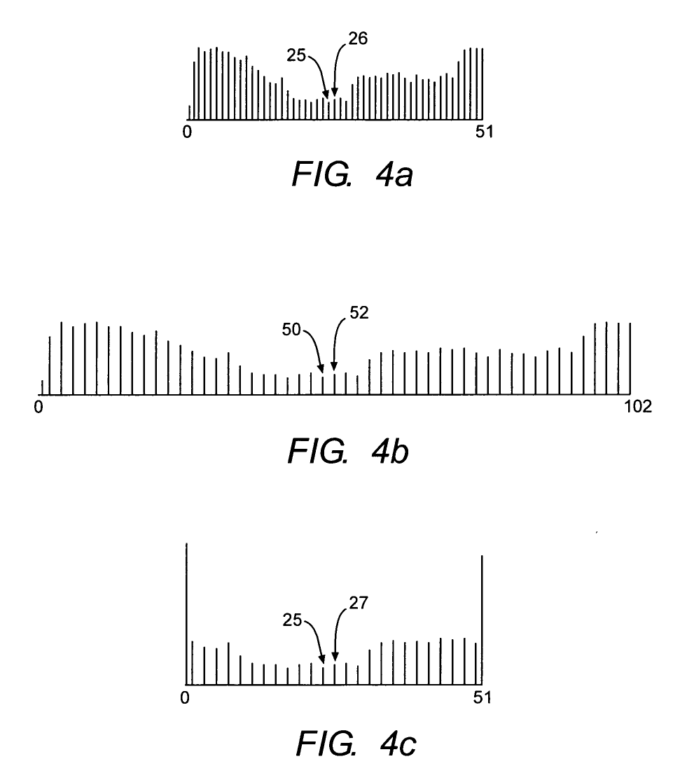

FIGS. 4a-c illustrate an example of one operation, sometimes referred to as “contrast stretching,” that may be performed by the pixel distribution module 66. FIG. 4a illustrates a histogram for an exemplary gray-scale image, showing the number of pixels at each of the level. For purposes of illustration, the shown image has only 51 level instead of the typical 256 levels. The exemplary operation manipulates the image's contrast, or the degree of difference between light and dark pixels. The larger the difference, the greater the contrast. The exemplary operation increases the contrast for pixels having adjacent levels of intensity by mapping the original pixels into new values. This increases the range of pixel values, however, the range of values that may be displayed is limited and it is not possible to display all of the pixels at their new levels. Accordingly, contrast increased only for pixels having mid-range values, and pixels at either end of the spectrum have their contrast eliminated. In other words, the difference between (mid-range) pixels having adjacent levels is increased, while pixels having levels at either end of the range are mapped into maximum and minimum levels.

The first step performed by the pixel distribution module 66 is the multiplying the level of each pixel of the source image by an expansion factor, in this case 2. This step doubles the range and increases the contrast between pixels. For instance, after the multiplication, source pixels with adjacent levels of 25 and 26 have respective new levels of 50 and 52, being separated by the level 51. FIG. 4b shows a histogram of the gray-scale image of FIG. 4b after the level of each pixel has been multiplied.

The second step performed by the pixel distribution module 66 is mapping pixels of the expanded range shown in FIG. 4b into the original range shown in FIG. 4a. FIG. 4c shows the results of the second step. The pixel distribution module 66 maps the new level of each pixel back into the original range by the addition or subtraction of an increment. In the example shown in FIG. 4c, the new pixel values are decremented by 25 as a first sub-step in mapping the pixels into the range of 0 to 51. In a second sub-step, the pixel distribution module examines each pixel's value after the subtraction. If the level is less than a minimum level, e.g., 0, or greater than a maximum level, e.g., 51, the pixel is mapped into the levels 0 and 51, respectively, of the original range, producing the spikes shown at each end of the histogram shown in FIG. 4c. If the level falls between the minimum and maximum levels, the new level becomes the value for the pixel. Thus, the source pixels with adjacent levels of 25 and 26 in FIG. 4a, would have their have respective levels increased to 50 and 52 in the first step, and would be mapped back into the original range in the second step by having their levels decremented by 25, yielding respective levels of 25 and 27 in FIG. 4c.

In the foregoing example, the expanded range is mapped back into the center of source range (by the subtraction of 25). In addition, the entire source range is expanded in the given example. The operations that may be performed by the pixel distribution module 66 are not limited to this example.

In alternative embodiments, the pixel distribution module 66, after the first step of expanding the pixel levels of the source image into another range, in the second step, centers the pixels of the new range about a point other than the center of the source range (by the subtraction of a value other than 25, or by the addition of a value). Further, in other embodiments, the pixel distribution module 66 does not map the entire range of levels of the source image into another range, but only maps one or more portions of the source range into one or more other ranges. The parameters for specifying the various ranges and center points are also stored in the registers 62b.

As mentioned, the pixel intensity and distribution modules 64, 66 may be employed individually or in combination. For instance, a user may only desire to manipulate the brightness or the contrast of a gray-scale image. However, if after manipulating the brightness of an image the user wishes to manipulate the contrast, he may do so. Referring again to FIG. 2, the control module 60 causes the output of the pixel intensity module 64 to be input to the pixel distribution module 66. Alternatively, if after manipulating the contrast of an image the user wishes to manipulate the brightness, the control module 60 causes the output of the pixel distribution module 66 to be input to the pixel intensity module 64.

As mentioned, the exemplary pixel modifying unit 58 manipulates only gray-scale images. RGB color images are comprised of three color channels. Each channel may be manipulated in the same manner as described above for the single gray-scale channel. Accordingly, the pixel modifying unit 58 may be adapted to manipulate color images, in one preferred embodiment, by providing pixel intensity and distribution modules 64, 66 for each color channel. A pixel modifying unit adapted for manipulating color images may change the brightness or contrast of a color image by simultaneously manipulating all three color changes by the same amount. In addition, the color adapted pixel modifying unit may remove or add a color cast to an image by manipulating a single color channel.

In a preferred embodiment, the pixel modifying unit is adapted for applying one or more special effects to an image. As an example of a special effect that a color adapted pixel modifying unit may perform is the replacement of one color with another. For instance, as pixels are fetched from memory, each pixel is evaluated to see if it falls with a particular range of colors, if so the pixel is replaced with a pixel of a different color. For example, if the range of red levels 175 to 255 is specified, pixels having levels in this range would have their red level set to a minimal value, while at the same time they would have their blue level set to the former red level.

A variety of different parameters are required to specify how different image manipulations are to be performed. In a preferred embodiment, these parameters are generally determined by software running on the host in response to input from the user. The host 22 communicates the parameters, together with commands to perform the desired operations, to the control module 60. Preferably, the parameters are stored by the control module 60 in the registers 62a, 62b. The parameters are made available to the pixel intensity and distribution modules 64, 66 by the control module 60 as necessary. In addition, the control module 60 performs its operations in accordance with the parameters stored in the registers 62a, 62b. While the parameters for specifying operations of modules 64, 66 are preferably specified in terms of values for multiplying and incrementing pixel levels, in an alternative embodiment, tables of values for adjusting pixel values may be stored in the registers 62a, 62b. For instance, the registers may store a table with 256 entries providing a unique adjustment for each gray scale or color channel level.

The output of the pixel modifying unit 58 is coupled to the display FIFO 54. Thus, after the pixels of a source image are fetched from memory, manipulated as desired by the pixel modifying unit 58, they are transmitted to the display FIFO 54 for rendering on the display device. If the user is satisfied with the appearance, he can provide input to the software running on the host 22 to store the image, as manipulated, in the secondary memory 29. Optionally, the manipulated image may be compressed by the CODEC 56 before being stored in the secondary memory.

If the user is not satisfied with the appearance of the image after a manipulation has been applied, he can provide input to the software running on the host 22 to discontinue the manipulation. The host 22 provides an appropriate command to the pixel modifying unit 58. For example, with reference to the gray-scale modifying unit 58 shown in FIG. 2, the host 22 may issue a command which causes an “on-off” bit in the parameter registers 62ato be set to off. This causes whatever operation the pixel intensity module 64 is performing to be discontinued. This appears to the viewer as an undoing of that manipulation. Similarly, the host 22 may issue a command which causes an “on-off” bit in the parameter registers 62b to be set to off. This causes whatever operation is being performed by the pixel distribution module 66 to be discontinued. This also appears to the viewer as an undoing of the module 66's manipulation.

As a second example of a user providing input to the software running on the host 22 to discontinue the manipulation, again with reference to the gray-scale modifying unit 58 shown in FIG. 2, assume that both the pixel intensity module 64 and the pixel distribution module 66 are active. In particular, assume that source pixels are fetched from memory, a first change to the pixels is made by the pixel intensity module 64. The first change is made according to first parameters stored in the registers 62a. The output of the pixel level module 64 is provided via the multiplexor 68 to the pixel distribution module 66 where a second change to the pixels is made by the pixel level module 64 according to second parameters stored in the registers 62b. If the user is not satisfied with the appearance of the image after the two manipulations have been applied, he can provide input to the software running on the host 22 to discontinue both manipulations. Alternatively, he can provide input to the software to discontinue either the manipulation performed by the pixel intensity module 64 or by the pixel distribution module 66.

In the examples above for providing an undo function for use when manipulating the appearance of an image, particular types of image manipulation were described. Specifically, modifying image brightness, contrast stretching, and color replacement. Each of these manipulations are capable of being performed one pixel at a time—by adding, subtracting, multiplying, or dividing the level of a pixel. It should be appreciated that present invention is not limited to the particular examples provided. The apparatus, system, and methods of the invention may be employed with any type of image manipulation that is capable of being performed one pixel at a time. For example, in alternative embodiments, manipulations may be employed such as reverse scaling (to create a negative of the original image), clipping, thresh-holding, intensity level slicing, bit extraction, and range compression. One skilled in the art will appreciate that these and other manipulations may be performed one pixel at a time.

Other manipulations are not performed one pixel at a time. To map an original pixel into a new level, these manipulations require knowledge of neighboring pixels in order. While the undo function of the present invention is preferably employed with manipulations performed one pixel at a time, in one alternative embodiment it is employed with a manipulation requiring values of an original pixel and its neighbors. In this embodiment a suitable buffer is provided. As one example, an image smoothing manipulation maps each original pixel into a level that is the weighted average of a defined group of neighbor pixels, such as a 3×3 pixel tile in which the central pixel is mapped into a level that is the sum to 1/9 times the level of each pixel in the tile. In this example, three line buffers would be provided. In another embodiment, each original pixel is mapped into a level that is the weighted average of a neighbor pixels on the same line, such as the pixels immediately to the right and to the left. In this example, a buffer suitable for storing two pixels would be provided. One skilled in the art will appreciate that other manipulations may be performed which require an original pixel and its neighbors. The present invention is intended to cover these other manipulations and not just the image smoothing manipulations just mentioned.

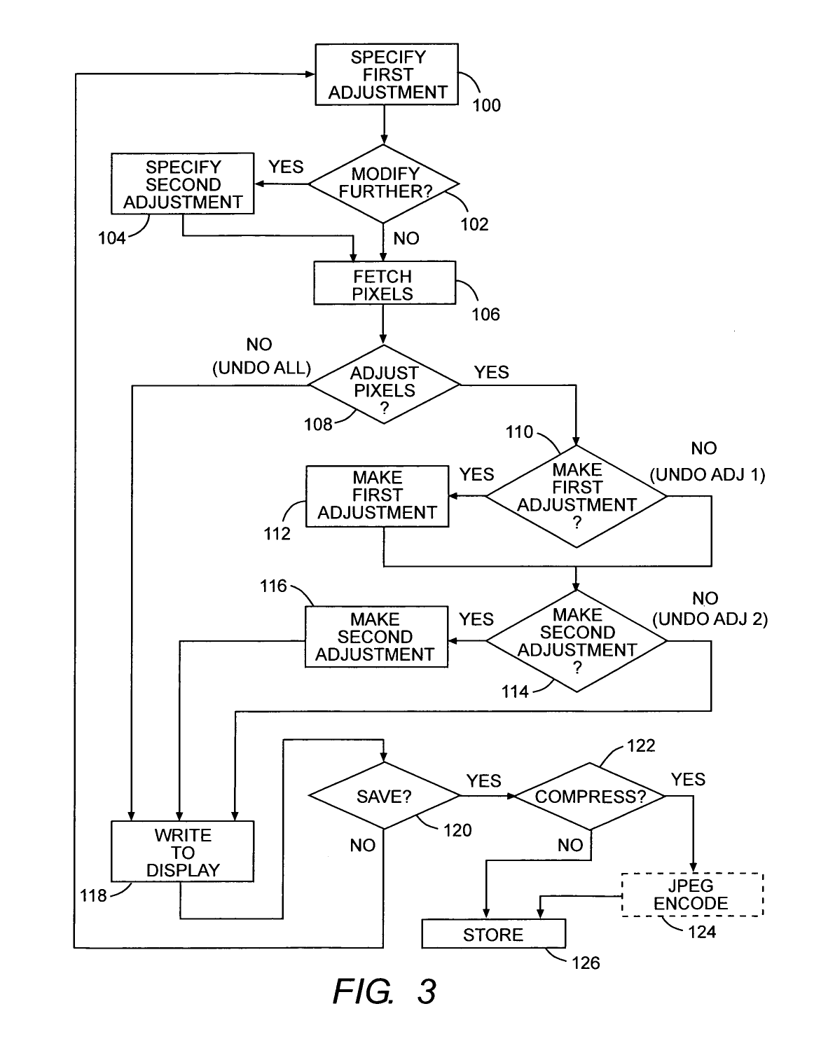

FIG. 3 shows a preferred method for manipulating the appearance of a digital image in which an undo function is provided. The method assumes that an image is stored in a memory. In a step 100, a manipulation or adjustment is specified. In a step 102, a determination is made as to whether the user desires a second adjustment. If a second adjustment is desired, it is specified in step 104. The adjustments specified in steps 100 and 104 may be to the level of all of the pixels in the image, such as a brightness adjustment. Alternatively, the adjustments may be to how the pixel levels are distributed in the image, such as a contrast adjustment. As one example, the first adjustment may be a brightness adjustment and the second adjustment may be a contrast adjustment. One of ordinary skill in the art will appreciate a variety of other adjustments may be made, some of which were enumerated above with regard to the apparatus shown in FIG. 2.

The pixels defining the image are fetched from a memory in a step 106. In a step 108, it is determined if it is necessary to adjust the pixel values to effect an image manipulation. If no image manipulation is required, the method proceeds to a step 118 where the pixels of the source image are written to the display without modification. On the other hand, if image manipulation is desired, the method moves to a step 110.

In a step 110, the method calls for determining if it is necessary to make the first adjustment (that was specified in step 100). Depending on the result of this determination, the first adjustment may be made in a step 112 or the method may proceed to a step 114. In the step 114, a determination is made if it is necessary to make the second adjustment (that may have been specified in step 104). If the second adjustment is to be made, the method moves to a step 116, in which the second adjustment is made. Alternatively, the method proceeds to the step 118.

As can be seen from the flow diagram, the step 118 for writing pixels to the display device may write: (a) source pixels that have not been adjusted; (b) source pixels that have been adjusted according to the first adjustment; (c) source pixels that have been adjusted according to the second adjustment; or (d) source pixels that have been adjusted according to the first and second adjustments.

From step 118, the user selects in a step 120 between modifying the image further or storing the image in a memory. If the user decides not to save the image, the method circles back to step 100. The user can move through the steps of the method to specify new first and second adjustments. In addition, the user can undo both the first and second adjustments at step 108, only the first adjustment at step 110, or only the second adjustment at step 114.

If the user decides in step 120 to save the image, the method moves to step 122. In step 122, a decision is made as to whether to optionally compression encode the image before storing it. If the image is to be encoded, the method moves to a step 124 in which it is compressed. The method then moves to a step 126. If the image is not to be encoded, the method moves directly to the step 126 in which it is written to memory. The memory is the secondary memory or the memory 50.

In the exemplary apparatus and system described above, a pixel intensity and a pixel distribution module were described. In other words, the exemplary apparatus provided for only two manipulations. In the method described above, a first and second adjustment were described. Again, the exemplary method provided for only two manipulations. It will be appreciated that two manipulations were described for purposes of clarity and that the present invention may be practiced with the required number of modules or steps for performing and undoing any number of manipulations.

In alternative embodiments, any part, or all, of the operations described herein that form part of the invention, can be embodied as computer readable code on a computer readable medium. Any data storage device that can store data and program instructions and that can be read by a host processor or other logic may be used as the computer readable medium. An electromagnetic carrier wave that embodies computer code may also be such computer readable medium. Examples of the computer readable medium include, but are not limited to, ROM, RAM, and flash memory ICs; hard drives; compact and floppy disks, magnetic tapes, and other optical and non-optical data storage devices.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

I claim:

1. A method for manipulating the appearance of a source image, comprising:
specifying at least one first parameter for changing pixel data defining a source image;
fetching the source pixel data from a memory;
writing pixel data to a display device; and
causing a first change to the source pixel data corresponding to the at least one first parameter before the step of writing the pixel data to the display device.

2. The method of claim 1, further comprising discontinuing the step of causing a first change, thereby reversing the first change.

3. The method of claim 1, further comprising:
specifying at least one second parameter for changing the pixel data; and
causing a second change to the pixel data corresponding to the at least one second parameter before the step of writing the pixel data the display device.

4. The method of claim 3, further comprising discontinuing the step of causing a second change, thereby reversing the second change.

5. The method of claim 3, further comprising discontinuing the step of causing a first change, thereby reversing the first change.

6. The method of claim 3, further comprising storing the pixel data in a memory after the step of causing a first change.

7. The method of claim 1, further comprising storing the pixel data in a memory after the step causing a second change.

8. The method of claim 1, wherein the first change is one of:
adding a value to the level of a pixel,
multiplying the level of a pixel,
adding a first value to the level of a pixel and multiplying the sum by a second value, and
multiplying the level of a pixel by a third value and adding a fourth value to the product.

9. The method of claim 1, wherein the first change includes mapping the level of a pixel into a new level derived from the original level and the level of at least one neighbor pixel.

10. A graphics controller, comprising:
image manipulation logic adapted for manipulating the appearance of an image and for undoing the manipulation which includes,
a fetching module for fetching source image pixel data from a source image memory;
a parameter memory for storing at least one first parameter for defining a manipulation of the source image pixel data;
a pixel modifying unit for causing a first manipulation of the source image pixel data corresponding to the at least one first parameter; and
a writing module adapted for receiving pixel data output from the pixel modifying unit and for writing the received pixel data to a display device.

11. The graphics controller of claim 10, wherein the pixel modifying unit is adapted to modify pixel data by one of:
adding a value to the level of a pixel,
multiplying the level of a pixel,
adding a first value to the level of a pixel and multiplying the sum by a second value, and
multiplying level of a pixel by a third value and adding a fourth value to the product.

12. The graphics controller of claim 10, wherein the pixel modifying unit is adapted to modify pixel data by mapping the level of a pixel into a new level derived from the original level and the level of at least one neighbor pixel.

13. The graphics controller of claim 10, further comprising a CODEC adapted for receiving pixel data output from the pixel modifying unit and for compressing the received pixel data.

14. The graphics controller of claim 10, further comprising storing logic adapted for receiving pixel data output from the pixel modifying unit and for writing the received pixel data to a memory.

15. A system, comprising:
a graphics controller adapted for manipulating the appearance of an image and for undoing the manipulation, the graphics controller including, image manipulation logic that includes:
a fetching module for fetching source image pixel data from a source image memory;
a parameter memory for storing at least one first parameter for defining a manipulation of the source image pixel data;
a pixel modifying unit for causing a first manipulation of the source image pixel data corresponding to the at least one first parameter; and
a writing module adapted for receiving pixel data output from the pixel modifying unit and for writing the received pixel data to a display device.

16. The system of claim 15, further comprising:
a host processor coupled with the graphics controller;
a secondary memory coupled with the graphics controller and the host processor;
a camera coupled with the graphics controller; and
a display device coupled with the graphics controller.

17. The system of claim 15, wherein the pixel modifying unit is adapted to modify pixel data by one of:
adding a value to the level of a pixel,
multiplying the level of a pixel,
adding a first value to the level of a pixel and multiplying the sum by a second value, and
multiplying level of a pixel by a third value and adding a fourth value to the product.

18. The system of claim 15, wherein the pixel modifying unit is adapted to modify pixel data by mapping the level of a pixel into a new level derived from the original level and the level of at least one neighbor pixel.

19. The system of claim 15, further comprising a CODEC for receiving pixel data output from the pixel modifying unit and for compressing the received pixel data.

20. The system of claim 15, further comprising storing logic adapted for receiving pixel data output from the pixel modifying unit and for writing the received pixel data to the secondary memory.
